(19) United States
(12) Patent Application Publication
(10) Pub. No.: US 2026/0122748 A1
(43) Pub. Date: Apr. 30, 2026

(54) LIGHTING DEVICE HAVING A REMOTELY CONTROLLABLE LIGHTING DISTRIBUTION

(71) Applicant: MaxLite Inc., Pine Brook, NJ (US)

(72) Inventor: Stephen Andrew Entrekin, Chester, NJ (US)

(21) Appl. No.: 18/928,302

(22) Filed: Oct. 28, 2024

(51) Int. Cl. H05B 47/155; F21V 5/04; F21Y 115/10; H05B 45/10; H05B 45/20; H05B 47/11; H05B 47/16; H05B 47/165; H05B 47/175; H05B 47/19

(52) U.S. Cl. CPC H05B 47/155; F21V 5/04; H05B 45/10; H05B 45/20; H05B 47/11; H05B 47/16; H05B 47/165; H05B 47/19; H05B 47/1965; F21Y 2115/10

(57) ABSTRACT

A lighting device includes a freeform lens configured to accommodate multiple light-emitting diodes (LEDs), allowing for different light distribution patterns based on the position of the LEDs. A processing device selectively activates specific LEDs to achieve a desired light distribution pattern. A transceiver facilitates wireless communication with an external user device, enabling remote control. One or more sensors detect environmental factors, and a memory stores algorithms and profiles for automatically adjusting lighting characteristics based on sensor data and commands from the transceiver. The device can operate using infrared or radio-frequency technology and includes a machine learning module to adjust lighting based on learned user preferences and sensor data. A method for remotely controlling the lighting characteristics involves wirelessly receiving commands to adjust light distribution patterns and automatically adjusting the patterns based on environmental factors and predefined algorithms.

### BACKGROUND

The present relates to lighting technology, specifically to lighting systems and devices that have remotely controllable light distribution adjustment systems.

### BACKGROUND

Conventional fixtures utilize lenses that are placed over light emitting diodes (LEDs) to capture and direct light into specific patterns. Altering the light pattern typically necessitates changing the lens covering the LED or adjusting the orientation of the LED chip under the lens. These methods involve mechanical processes that require labor and additional materials or components.

Existing solutions lack the capability to change the light distribution patterns wirelessly. Users manually handle the fixture to make these adjustments, which can be labor-intensive and inconvenient. There is a need for a system that allows users to modify these parameters remotely without physical interaction with the fixture.

### SUMMARY

According to one aspect of the present invention, a lighting device includes a freeform lens configured to accommodate a plurality of light-emitting diodes (LEDs), wherein a geometry of the freeform lens allows for different light distribution patterns based on a position of the LEDs under the lens. The lighting device also includes a processing device configured to selectively activate specific LEDs based on a desired light distribution pattern, a transceiver configured to facilitate wireless communication with an external user device, and one or more sensors configured to detect environmental factors. The lighting device can also include a memory connected to the processing device, the memory storing algorithms and profiles for automatically adjusting characteristics of lighting provided by the lighting device based on data received from the sensors and commands from the transceiver.

According to another aspect, the transceiver is configured to operate using infrared technology.

According to yet another aspect, the transceiver is configured to operate using radio-frequency technology.

According to another aspect, the processing device is a microcontroller.

According to yet another aspect, the one or more sensors include a brightness sensor.

According to another aspect, the lighting device further comprises a machine learning module that is configured to adjust the lighting characteristics based on learned user preferences and sensor data.

According to yet another aspect, the memory stores a lighting profile that includes parameters for lighting distribution, temperature, and brightness level.

According to another aspect, the freeform lens is a freeform lens is configured to create IES patterns selected from the group consisting of Type III, Type IV, and Type V.

According to yet another aspect, a method for remotely controlling lighting characteristics of a lighting device having a freeform lens configured to accommodate a plurality of light-emitting diodes (LEDs), a processing device, a transceiver, one or more sensors, and a memory, the method comprises wirelessly receiving, via the transceiver, a command from an external user device to adjust a light distribution pattern; and selectively activating, by the processing device, specific LEDs based on the received command to achieve the light distribution pattern.

According to another aspect, the method further comprises detecting, by the one or more sensors, environmental factors surrounding the lighting device; and automatically adjusting, by the processing device, the light distribution pattern based on the detected environmental factors and predefined algorithms stored in the memory.

According to yet another aspect, the method further comprises wirelessly transmitting, via the transceiver, a command to a second lighting device to adjust a lighting light distribution pattern of the second lighting device.

According to another aspect, the method further comprises automatically adjusting the light distribution pattern based on a time of day.

According to yet another aspect, the command from the external user device is sent using a smartphone app.

According to another aspect, the method further comprises storing multiple lighting profiles in the memory.

According to yet another aspect, the method further comprises using machine learning to predict future lighting needs based on sensor data.

According to another aspect, the transceiver is configured to operate using radio frequency technology.

The above features and advantages, and other features and advantages of the disclosure are readily apparent from the following detailed description when taken in connection with the accompanying drawings.

### BRIEF DESCRIPTION OF THE DRAWINGS

FIG. 1A is a block diagram illustrating the components of a lighting device with remotely controllable light distribution in accordance with an exemplary embodiment.

FIG. 1B illustrates a lighting fixture with multiple LEDs arranged under a freeform lens to create different light distribution patterns in accordance with an exemplary embodiment.

FIG. 2 illustrates a schematic block diagram illustrating a system for remotely controlling lighting devices via a communications network in accordance with an exemplary embodiment.

FIG. 3 illustrates a system for distributing light across an area using multiple lighting devices.

FIG. 4 illustrates a schematic flow chart diagram of a method for creating and transmitting a lighting profile to a lighting device.

FIG. 5 illustrates a schematic flow chart diagram of a method for controlling a lighting device based on a lighting profile in accordance with an embodiment.

### DETAILED DESCRIPTION

Conventional light fixtures utilize freeform lenses placed over light emitting diodes (LEDs) to capture and direct light into specific patterns. These fixtures require mechanical processes to alter the light pattern, either by changing the lens covering the LED or adjusting the orientation of the LED chip under the lens. These methods necessitate labor and additional materials or components, making the process cumbersome and inefficient. Existing solutions lack the capability to change light distribution patterns wirelessly. Users manually handle the fixture to make these adjustments, which can be labor-intensive and inconvenient. This manual intervention not only increases the time and effort required but also limits the flexibility and responsiveness of the lighting system. There is a need for a system that allows users to modify these parameters remotely without physical interaction with the fixture.

The present system addresses these issues by enabling users to change both Correlated Color Temperature (CCT) and the IES light distribution pattern for light fixtures using wireless electronic controls, such as with Infrared or Bluetooth. This system eliminates the need for separate fixture components or manual handling to make these changes. Users can perform CCT and distribution adjustments on demand, from a distance of up to 40-50 feet, without touching the fixture. The system includes a lighting fixture having a freeform lens large enough to accommodate multiple LEDs, a circuitry designed to activate specific LEDs based on the desired pattern and CCT, and a microprocessor to manage the switching and activation of relevant circuits. In exemplary embodiments, the microprocessor can be controlled via a remote control with infrared or an app using Bluetooth, providing a seamless and efficient way to manage lighting parameters.

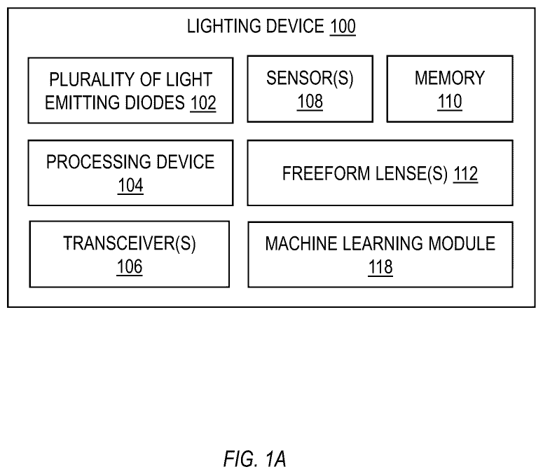

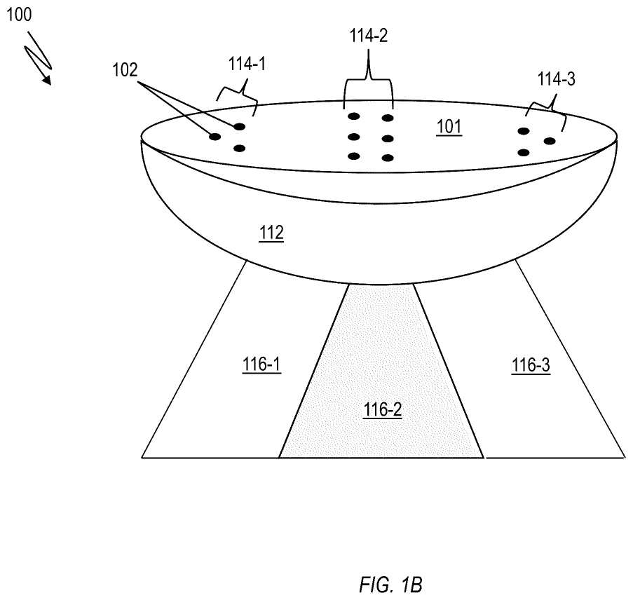

Referring now to FIG. 1, a block diagram illustrating the components of a lighting device 100 with remotely controllable light distribution in accordance with an exemplary embodiment is shown. The lighting device 100 includes several components that work together to enable remotely controllable light distribution. In exemplary embodiments, the lighting device 100 includes a plurality of LEDs 102 are positioned under a freeform lens 112. The freeform lens 112 is configured to capture and direct the light emitted by the LEDs 102 into specific patterns or lighting distributions. The freeform lens 112 is designed to accommodate multiple LEDs 102, allowing for various light distribution patterns depending on which LEDs 102 are activated. In exemplary embodiments, the plurality of LEDs 102 may also have different color temperatures and the lighting device 100 is configured to be able to adjust the color temperature and distribution pattern.

The processing device 104 is connected to the LEDs 102 and is responsible for managing the activation of specific LEDs 102 based on the desired light distribution pattern, the desired color temperature, and or the desired brightness. Examples of processing devices 104 that may be used in the lighting device include microcontrollers (MCUs), such as the ARM Cortex-M series, Atmel AVR, and Microchip PIC microcontrollers, which are compact integrated circuits designed to govern specific operations in embedded systems. Microprocessors, like the Intel Atom, ARM Cortex-A series, and AMD Ryzen Embedded processors, can be used for more complex processing tasks. Field-Programmable Gate Arrays (FPGAs), including Xilinx Zynq, Intel (formerly Altera) Cyclone, and Lattice Semiconductor FPGAs, are integrated circuits that can be configured by the customer or designer after manufacturing. System on Chips (SoCs), such as the Qualcomm Snapdragon, NVIDIA Tegra, and Broadcom BCM series, integrate all components of a computer or other electronic system into a single chip. Digital Signal Processors (DSPs), like the Texas Instruments TMS320 series and Analog Devices SHARC processors, are specialized microprocessors designed specifically for digital signal processing tasks. Additionally, Application-Specific Integrated Circuits (ASICs), which are custom-designed chips tailored for specific applications, include custom ASICs designed by companies like Apple, Google, and Samsung for their specific hardware needs. In exemplary embodiments, the processing device 104 receives commands from the transceiver(s) 106, which facilitates wireless communication with external devices.

In exemplary embodiments, the transceiver(s) 106 can operate using either infrared or radiofrequency (RF) technology, allowing users to control the lighting device 100 remotely. Examples of infrared transceivers include the Vishay TSOP series and the Everlight IRM series, which are commonly used for remote control applications. For RF technology, examples include Bluetooth transceivers such as the Nordic Semiconductor nRF52 series and the Texas Instruments CC2640 series, which provide robust wireless communication capabilities. Additionally, Wi-Fi transceivers like the Espressif ESP8266 and ESP32 series can be used to enable remote control over a local network or the internet.

In exemplary embodiments, one or more sensor(s) 108 are integrated into the lighting device 100 to provide additional functionality. These sensor(s) 108 can detect various environmental factors such as brightness levels, location, and other relevant parameters. The data collected by the sensor(s) 108 can be used by the processing device 104 to adjust the lighting characteristics automatically based on predefined algorithms or user preferences stored in the memory 110. For instance, if the sensor(s) 108 detects a decrease in ambient light levels, the processing device 104 can automatically increase the brightness of the LEDs to maintain a consistent illumination level. Additionally, the sensor(s) 108 can monitor the time of day and adjust the lighting distribution pattern and/or color temperature to mimic natural daylight patterns, providing cooler light in the morning and warmer light in the evening. These adjustments are made based on algorithms and user preferences stored in the memory 110, ensuring that the lighting device operates autonomously and efficiently to meet the users'needs.

In exemplary embodiments, the memory 110 is connected to the processing device 104 and stores the algorithms, profiles, and user preferences for adjusting the lighting characteristics. The memory 110 ensures that the lighting device 100 can operate autonomously and make adjustments based on the data received from the sensor(s) 108 and the commands from the transceiver(s) 106.

In exemplary embodiments, the freeform lens 112 is a component that works in conjunction with the LEDs 102 to create different light distribution patterns. In exemplary embodiments, the freeform lens 112 is a Total Internal Reflection (TIR) lens functions by capturing and directing light emitted from the LEDs 102 into specific patterns through the principle of total internal reflection. When light enters the TIR lens, it is refracted at the interface between the lens material and the surrounding air. If the angle of incidence is greater than the critical angle, the light is reflected entirely within the lens material, rather than passing through the interface. This internal reflection continues until the light exits the lens at a controlled angle, allowing for precise direction and distribution of the light. The freeform lens 112 is structured to accommodate multiple LEDs 102, and the geometry of the freeform lens 112 allows for various IES patterns such as Type III, IV, or V, depending on the position of the LEDs 102 under the lens. The processing device 104 selectively activates the relevant LEDs 102 to achieve the desired light distribution pattern.

In exemplary embodiments, the machine learning module 118 in the lighting device 100 is designed to enhance the system's ability to automatically adjust lighting patterns based on learned user preferences and sensor data. This module can perform several functions to optimize the lighting environment. In one embodiment, the machine learning module 118 can analyze historical data on user interactions with the lighting device 100. For example, it can learn that a user prefers a different lighting distribution pattern in the morning than during the evening. Based on this learned behavior, the module can automatically adjust the lighting distribution pattern at different times of the day to match the user's preferences. The machine learning module 118 can also use data from the sensor(s) 108 to adapt the lighting pattern in real-time. For instance, if the sensor(s) detect a decrease in ambient light levels, the module can increase the brightness of the LEDs to maintain a consistent illumination level. Conversely, if the sensor(s) detect an increase in natural light, the module can dim the LEDs to save energy while maintaining the desired lighting conditions. In addition, the machine learning module 118 can predict future lighting needs based on patterns in the sensor data and user interactions.

In exemplary embodiments, the machine learning module 118 can adjust the lighting based on the context of the environment, particularly for outdoor lights, by considering factors such as geographical location, the time of year, and changes in the angle of the sun. For instance, the module can use geographical location data to determine the precise sunrise and sunset times for a specific area. By doing so, it can automatically adjust the lighting schedule to ensure that outdoor lights turn on at dusk and turn off at dawn, optimizing energy usage and enhancing safety. Additionally, the machine learning module 118 can account for the time of year to make seasonal adjustments to the lighting. During the winter months, when days are shorter, the module can extend the duration of lighting to compensate for the reduced daylight hours. Conversely, during the summer months, when days are longer, the module can reduce the lighting duration to save energy while still providing adequate illumination. Furthermore, the module can adjust the lighting based on changes in the angle of the sun throughout the year. For example, as the sun's angle changes with the seasons, the module can modify the direction and intensity of the outdoor lights to ensure optimal coverage and minimize shadows. This can be particularly useful for areas such as parking lots, pathways, and public spaces, where consistent and effective lighting is crucial for safety and visibility. By leveraging the capabilities of the machine learning module 118, outdoor lighting systems can provide a highly adaptive and responsive lighting environment that meets the specific needs of the location and time of year. This not only enhances the user experience but also optimizes energy usage and improves overall efficiency.

FIG. 1B shows a lighting device 100 with multiple light-emitting diodes (LEDs) 102 arranged under a freeform lens 112 to create different light distribution patterns. The lighting device 100 includes a printed circuit board 101, a first group of LEDs 114-1, a second group of LEDs 114-2, a third group of LEDs 114-3, a first lighting distribution 116-1, a second lighting distribution 116-2, and a third lighting distribution 116-3. The LEDs 102 are positioned on the printed circuit board 101 and are responsible for emitting light. The LEDs 102 are arranged in groups to facilitate different lighting distributions. The printed circuit board 101 provides the necessary electrical connections and support for the LEDs 102.

In exemplary embodiments, the first group of LEDs 114-1 is a subset of the LEDs 102 arranged to produce the first lighting distribution 116-1. The first group of LEDs 114-1 is positioned under the freeform lens 112 to direct light into the freeform lens 112 to create a first lighting distribution 116-1. The first group of LEDs 114-1 can be activated independently to provide the first lighting distribution 116-1. The second group of LEDs 114-2 is a subset of the LEDs 102 arranged to produce the second lighting distribution 116-2. The second group of LEDs 114-2 is positioned under the freeform lens 112 to direct light into the freeform lens 112 to create a first lighting distribution 116-2. The second group of LEDs 114-2 can be activated independently to provide the second lighting distribution 116-1. The third group of LEDs 114-3 is a subset of the LEDs 102 arranged to produce the first lighting distribution 116-1. The third group of LEDs 114-3 is positioned under the freeform lens 112 to direct light into the freeform lens 112 to create a third lighting distribution 116-3. The first group of LEDs 114-1 can be activated independently to provide the third lighting distribution 116-3.

In exemplary embodiments, the first lighting distribution 116-1, second lighting distribution 116-2, and third lighting distribution 116-3 represent different lighting distribution patterns that can be achieved by selectively activating the first group of LEDs 114-1, the second group of LEDs 114-2, and the third group of LEDs 114-3, respectively. These lighting distributions provide flexibility in adjusting the lighting characteristics to meet different requirements.

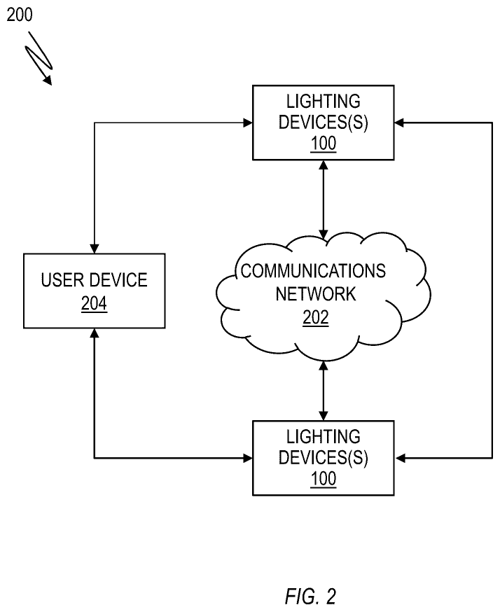

Referring now to FIG. 2, a system 200 for remotely controlling lighting devices via a communications network is shown. The system 200 includes one or more lighting devices 100, a user device 204, and optionally a communications network 202. In one embodiment, lighting devices 100 are configured to receive commands from the user device 204 through the communications network 202. The user device 204 can be a remote control, a smartphone, or any other device capable of wireless communication. The user device 204 allows users to adjust the lighting characteristics of the lighting device 100 remotely, providing convenience and flexibility. The user device 204 communicates with the lighting device 100 through the communications network 202. The communications network 202 can be a local network, such as wi-fi, or a broader network, such as the Internet. The communications network 202 ensures that the commands from the user device 204 are transmitted to the lighting device 100 efficiently and reliably. In another embodiment, the user device 204 is configured to communicate directly with the lighting device 100. In exemplary embodiments, the system 200 includes multiple lighting devices 100 that may be configured to communicate with one another either directly or via the communications network. In a system having multiple lighting devices 100, the user device 204 may send a command to one the lighting device 100 and that lighting device may retransmit the received command to the additional lighting devices, either directly or through the communications network 202.

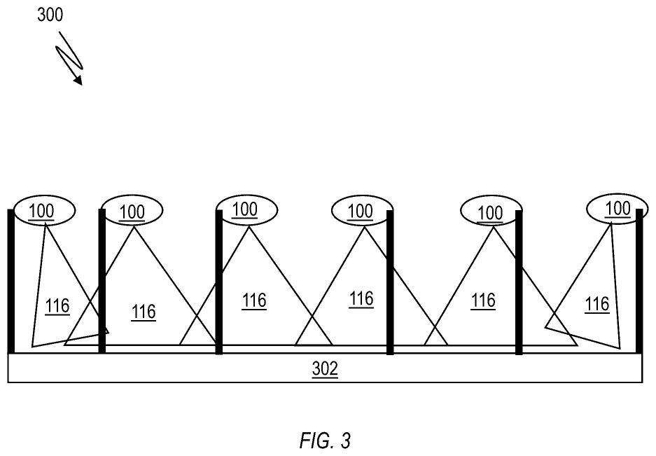

Referring now to FIG. 3 a system 300 for distributing light across an area 302, such as a parking lot or the interior of a store, using multiple lighting devices 100 is shown. The system 300 includes several lighting devices 100 arranged to provide uniform lighting distribution 116 over the area 302. In exemplary embodiments, each lighting device 100 is positioned strategically to ensure optimal light coverage across the area 302. The lighting devices 100 are configured to work in unison to achieve the desired lighting distribution 116. In exemplary embodiments, each lighting device 100 is configured to output an individually controlled light distribution 116. The lighting devices 100 each include components that enable the lighting device 100 to emit light and adjust the lighting device 100's distribution pattern, color temperature, and brightness. The lighting device 100 can be controlled remotely to modify the light distribution 116, ensuring that the area 302 receives consistent and adequate illumination. The area 302 represents the region that the system 300 aims to illuminate. The arrangement of the lighting devices 100 and their respective lighting distributions 116 ensures that the light is distributed evenly across the area 302, minimizing shadows and dark spots. The lighting distribution 116 refers to the pattern and intensity of light emitted by the lighting devices 100. The system 300 allows for adjustments to the lighting distribution 116 to meet specific requirements, ensuring that area 302 is well-lit under various conditions. As illustrated, the lighting distribution 116 of each lighting device 100 in the system 300 may be different from one another.

In an exemplary embodiment, a user with a remote device that includes a light sensor traverses the area 302 to gather lighting levels and responsively adjust the lighting distribution and brightness of various lighting devices 100 responsible for providing lighting in the area 302. The remote device, which could be a smartphone or a specialized remote control, is equipped with a light sensor capable of measuring the ambient light levels at different locations within the area 302. As the user moves through the area 302, the light sensor on the remote device continuously collects data on the current lighting conditions. This data is then transmitted to the lighting devices 100 via a communications network 202 or directly through a wireless connection. The processing device 104 within each lighting device 100 receives the data and analyzes it to determine if adjustments are needed to achieve optimal lighting conditions. Based on the collected data, the processing device 104 can adjust the lighting distribution and brightness of the LEDs 102 in real-time. For instance, if the light sensor detects a dimly lit area, the processing device 104 can increase the brightness of the LEDs 102 in the nearest lighting device 100 to enhance illumination. Conversely, if an area is overly bright, the processing device 104 can reduce the brightness to save energy and prevent glare. Additionally, the processing device 104 can modify the lighting distribution pattern by selectively activating specific groups of LEDs 114-1, 114-2, and 114-3 under the freeform lens 112. This allows the lighting device 100 to direct light more precisely to areas that require additional illumination, ensuring a uniform lighting distribution across the entire area 302. This embodiment provides a dynamic and responsive lighting system that can adapt to changing conditions and user preferences. By leveraging the capabilities of the remote device with a light sensor, the system ensures that the area 302 is consistently well-lit, enhancing safety, visibility, and overall user experience.

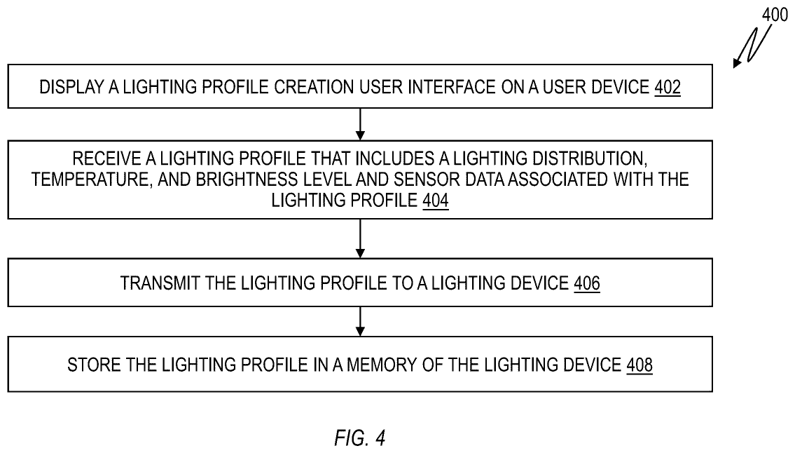

Referring now to FIG. 4, a method 400 for creating and transmitting a lighting profile to a lighting device is shown. The method 400 can be implemented by a user device, such as a smartphone or a computer, to facilitate the remote control and customization of lighting characteristics. At step 402, the method 400 includes displaying a lighting profile creation user interface on a user device. This user interface allows the user to input and adjust various parameters related to the lighting profile, such as lighting distribution, temperature, and brightness level. Next, as shown at step 404, the method 400 includes receiving a lighting profile that includes a lighting distribution, temperature, and brightness level, along with sensor data associated with the lighting profile. The user inputs these parameters through the user interface, and the user device compiles them into a comprehensive lighting profile. At step 406, the method 400 includes transmitting the lighting profile to a lighting device. The user device sends the compiled lighting profile to the lighting device via a communications network or a direct wireless connection. Next, as shown at step 408, the method 400 includes storing the lighting profile in a memory of the lighting device. The lighting device receives the lighting profile and saves the lighting profile in the memory of the lighting device, enabling the device to adjust the lighting characteristics of the device according to the stored profile.

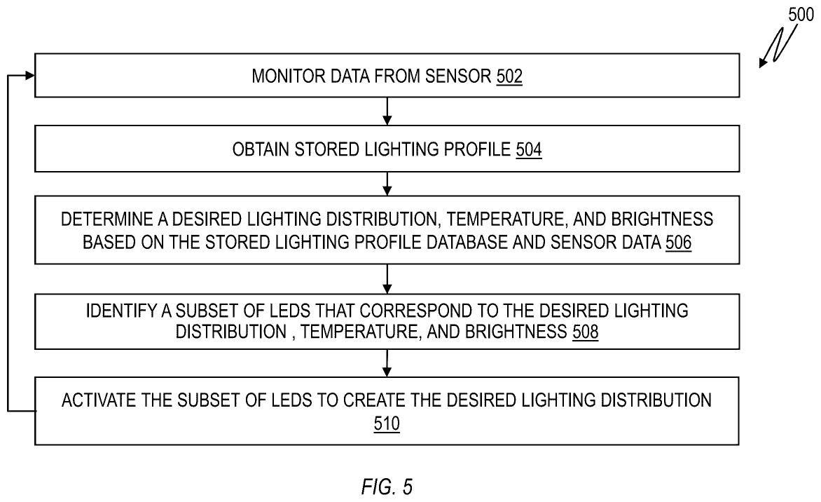

Referring now to FIG. 5, a method 500 for controlling a lighting device based on a lighting profile is shown. The method 500 can be implemented by a lighting device, such as the lighting device 100 shown in FIG. 1A. At step 502, the method 500 includes monitors data from one or more sensors disposed within the lighting device. The sensor(s) collect various environmental factors such as brightness levels, location, and other relevant parameters. This data is used for adjusting the lighting characteristics automatically based on predefined algorithms or user preferences. Next, as shown at step 504, the method 500 includes obtaining a stored lighting profile. The stored lighting profile includes parameters related to lighting distribution, temperature, and brightness level. The lighting device retrieves this profile from a database or memory where the profile has been previously saved. At step 506, the method 500 includes determining a desired lighting distribution, temperature, and brightness based on the stored lighting profile database and sensor data. The processing device analyzes the retrieved profile and the real-time data from the sensor to decide the optimal lighting characteristics. Next, as shown at step 508, the method 500 includes identifying a subset of LEDs that correspond to the desired lighting distribution, temperature, and brightness. The processing device selects specific LEDs that need to be activated to achieve the desired lighting characteristics. At step 510, the method 500 includes activating the subset of LEDs to create the desired lighting distribution. The selected LEDs are turned on or adjusted to match the lighting profile, ensuring that the lighting device emits light according to the user's preferences and environmental conditions.

In one embodiment, a lighting device is installed in an office space. The lighting device is equipped with sensors that continuously monitor the ambient lighting levels in the room. The device also has a stored lighting profile that includes parameters for optimal lighting distribution, temperature, and brightness levels for different conditions. One afternoon, as clouds cover the sun, the ambient light levels in the office begin to decrease. The sensors detect this change and send the data to the processing device within the lighting system. The processing device then retrieves the stored lighting profile, which specifies the desired lighting characteristics for such conditions. Based on the stored profile and the real-time sensor data, the processing device determines that the current lighting distribution and brightness levels are insufficient to maintain optimal illumination. To address this, the processing device identifies a subset of LEDs that need to be activated or adjusted to compensate for the reduced ambient light. The processing device then activates additional LEDs and increases the brightness of the existing ones to enhance the overall illumination. It also adjusts the lighting distribution pattern to ensure that light is directed more effectively to areas that have become dimmer. For instance, the device might switch from a broad, diffuse lighting pattern to a more focused one that targets specific workspaces or areas where more light is needed. As a result, the office space remains well-lit despite the decrease in natural light, ensuring that employees can continue to work comfortably and efficiently. Conversely, if the clouds clear and the ambient light levels increase, the sensors will detect this change, and the processing device will again refer to the stored lighting profile. It may then reduce the brightness or deactivate some LEDs to prevent over-illumination and save energy, maintaining a balanced and efficient lighting environment.

In exemplary embodiments, the freeform lens 112 may take various forms, including aspheric lenses, faceted lenses, prismatic lenses, Fresnel lenses, lens arrays, and hybrid lenses. Aspheric lenses feature a varying curvature that minimizes spherical aberration, resulting in sharper images and improved light control. Faceted lenses, designed with multiple flat surfaces, direct light in specific patterns and are often used for spotlighting and accent lighting. Prismatic lenses utilize prisms to refract light, creating captivating visual effects and managing glare, making them popular in decorative and task lighting. Fresnel lenses are thin and lightweight, featuring a series of concentric grooves that allow for effective light focusing and diffusion, commonly employed in stage lighting. Lens arrays consist of multiple small lenses arranged in a pattern, enabling the achievement of specific beam shapes or light distribution, which is particularly useful in area lighting. Finally, hybrid lenses combine features from different types of lenses, allowing for customization for specific lighting applications, thereby enhancing performance and versatility

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1.-9. (canceled)

10. A method for remotely controlling lighting characteristics of a lighting device having a freeform lens configured to accommodate a plurality of light-emitting diodes (LEDs), a processing device, and a transceiver, the method comprising:
wirelessly receiving, via the transceiver, a command from an external user device to adjust a light distribution pattern; and
selectively activating, by the processing device, specific LEDs based on the received command to achieve the light distribution pattern.

11. The method of claim 10, further comprising:
detecting, by one or more sensors, environmental factors surrounding the lighting device; and
automatically adjusting, by the processing device, the light distribution pattern based on the detected environmental factors and predefined algorithms stored in a memory of the lighting device.

12. The method of claim 10, further comprising wirelessly transmitting, via the transceiver, a command to a second lighting device to adjust a lighting light distribution pattern of the second lighting device.

13. The method of claim 10, further comprising automatically adjusting the light distribution pattern based on a time of day.

14. The method of claim 10, wherein the command from the external user device is sent using a smartphone app.

15. The method of claim 10, further comprising storing multiple lighting profiles in a memory of the lighting device.

16. The method of claim 10, further comprising using machine learning to predict future lighting needs based on sensor data.

17. The method of claim 10, wherein the transceiver is configured to operate using radio frequency technology.
